(19) United States
(12) Patent Application Publication
(10) Pub. No.: US 2014/0351442 A1
(43) Pub. Date: Nov. 27, 2014

(54) A METHOD TO MINIMIZE NETWORK AND INFORMATION TECHNOLOGY RESOURCES CONSUMPTION IN CONVERGED NETWORKS WHEN PROVISIONING SERVICES

(71) Applicant: TELEFONICA, S.A., Madrid (ES)

(72) Inventors: Juan Fernandez-Palacios, Madrid (ES); Oscar Gonzalez, Madrid (ES); Luis Miguel Contreras, Madrid (ES); Alejandro Tovar De Duenas, Madrid (ES)

(73) Assignee: TELEFONICA, S.A., Madrid (ES)

(21) Appl. No.: 14/365,440

(22) PCT Filed: Dec. 7, 2012
(86) PCT No.: PCT/EP2012/074826

§ 371 Date: Jun. 13, 2014

(30) Foreign Application Priority Data
Dec. 14, 2011 (ES) P201132011

(51) Int. Cl. H04L 12/24

(52) U.S. Cl. CPC H04L 41/5029
USPC 709/226

(57) ABSTRACT

In the method of the invention said services include Information Technology, or IT, and scheduled services and said converged networks implement Policy Control and Charging Rules Function, or PCRF and advanced Path Computation Element, or PCE+ in a 3rd Generation Partnership Project architecture.

It is characterised in that it comprises performing a communication procedure between a PCRF module and a PCE+ module by means of an adaptor entity in order to provide, said PCE+ module, information to said PCRF module, said PCRF module using said information to at least allocate network and/or IT resources demanded when provisioning said services.

### FIELD OF THE ART

The present invention generally relates to a method to minimize network and Information Technology resources consumption in converged networks when provisioning services, said services including Information Technology, or IT, resources (e.g., storage capacity, CPU, etc) and scheduled services, said converged networks implementing Policy Control and Charging Rules Function, or PCRF and advanced Path Computation Element, or PCE+ in a 3rd Generation Partnership Project architecture and more particularly to a method that comprises performing a communication procedure between a PCRF module and a PCE+ module by means of an adaptor entity in order to provide, said PCE+ module, information to said PCRF module, said PCRF module using said information to at least allocate network and/or IT resources demanded when provisioning said services.

### PRIOR STATE OF THE ART

The existing technologies for QoS control in current 3GPP based architechtures and an advanced PCE with IT aware capabilities are described next:

3GPP—PCFR [1]

Policy control platforms enable to allocate bandwidth, warranty QoS, and access to network resources based on application/user profiles. A common approach to provide mechanisms for traffic handling in IP access networks is PCRF.

PCRF is the core of 3GPP dynamic policy architecture. From the architecture perspective, applications ask for network resource allocation in real time. The PCRF is able to instruct dynamically on the QoS policy to enforce to almost every node in the network, such as BRAS, GGSN or DPI nodes. The policy parameters to be dynamically enforced will depend mainly on the enforcement point (e.g. BRAS) capabilities and on the access technology. The dynamic traffic policy evaluation may depend on several parameters and it is up to the operator business model to decide the conditions that will trigger the actions on the network and the parameters being used.

PCRF is defined within the context of the IMS specifications. According to 3GPP IMS model, QoS control is based on the following principles:

A central view is kept of all network resources.

Requests for network resources are accepted or denied individually and on request.

Requests for network resources can be made by end users and by application service providers.

Resources are reserved after a request has been accepted and released after the session has finished.

Requests, acceptance and reservation of network resources can be handled independently for the upstream and downstream directions.

According to 3GPP IMS definition, the Policy and Charging Rules Function (PCRF) is in charge of assuring the required QoS for each incoming request, as it will be shown in FIG. 1.

The Application Function (AF) communicates with the PCRF to transfer dynamic QoS-related application information.

The PCRF checks whether the requested QoS can be made available for the involved application (admission control). This decision is made applying the access policies to the provision request of such QoS with regard to the subscriber specific data provided by the Subscriber Policy Register (SPR). Policies are defined by the operator.

The Access Gateway (AWG) acts as the Policy and Charging Enforcement Function (PCEF), the entity in charge of apply the rules defined within the PCRF to the actual data flows on the traffic plane. Possible policy enforcement procedures for authorized QoS include Packet scheduling, data packet (Diffserv) marking, and packet discarding.

IT Aware PCE [2]

The Path Computation Element (PCE) is the network element in charge of providing the best route to communicate the origin and destine end-points. The determination of the best route can be based on metrics like distance or cost.

The information exchange between a PCE and a client node follows the PCEP protocol (it is a client/server protocol based on request/response messages), which is defined and in continuous extension by the IETF. One of the extensions is devoted to generalize the definition of End-points. The EU project GEYSERS [3] has gone beyond introducing in this generalization the possibility to define IT resources as End-points in a Path request. This last extension is the enabler of composed services integrating connectivity and IT resources [4].

FIG. 2 will show the GEYSERS' extended PCE (PCE+) within a network with coupled IT resources. As mentioned before, GEYSERS' PCEP extensions allow the communication of information about IT resources availabilities/capabilities facilitating four different connectivity services:

Unicast service: the PCC (Path Computation Client) specifies in the request the pair origin-destine and the PCE+ provides in response the optimum path between them from a network perspective.

Assisted unicast service: the PCC specifies in the request a set of origin-destination pairs and the PCE+ responds with a quotation for each origin-destination path according to network cost or performance.

Restricted anycast service: the PCC specifies in the request a set of origin-destination pairs and the PCE responds with the origin-destination pair and path that optimizes performance regarding both IT and network.

Anycast service: the PCC specifies in the request an origin and a description of the IT capabilities that must have the destination and the PCE responds with the path from the origin towards the destination that best fit the requested capabilities, thus optimizing both IT and network resource allocation.

Problems with Existing Solutions

The main problem with existing solutions in this context is the lack of integration between the two commented technologies. In the current state, policy control in the PCRF is done with mutual unawareness between network provision and IT provision, carrying inconveniences like:

Time consumption: Currently, provisioning processes are independent for IT and network. It implies that there is a long time needed to prepare the support of a service including IT and connectivity, especially when human intervention is needed (through management systems).

Sub-optimal joint provision: Optimal provision can be achieved independently in both domains, but the intersection of this two optimal provisions will not necessarily be optimal in global terms e.g.: data exchange between two servers —optimums for certain application—separated for a long distance can traduce in a low application performance.

Another issue with the 3GPP-PCRF is that in its current definition it provides resource access/denial with regard of resource availability at the moment of the request, what means that in case of denial the application layer must resend the request again once there are free resources.

### DESCRIPTION OF THE INVENTION

It is necessary to offer an alternative to the state of the art which covers the gaps found therein, particularly related to the lack of proposals which really fulfil the requirements in terms of automatic operation and optimization in the provisioning of resources for the support of services integrating connectivity and IT over a 3GPP based architecture.

To that end, the present invention provides a method to minimize network and Information Technology resources consumption in converged networks when provisioning services, said services including Information Technology, or IT, and scheduled services and said converged networks implementing Policy Control and Charging Rules Function, or PCRF and advanced Path Computation Element, or PCE+ in a 3rd Generation Partnership Project architecture.

On the contrary to the known proposals, the method of the invention, in a characteristic manner it comprises performing a communication procedure between a PCRF module and a PCE+ module by means of an adaptor entity in order to provide, said PCE+ module, information to said PCRF module, said PCRF module using said information to at least allocate network and/or IT resources demanded when provisioning said services.

Other embodiments of the method of the first aspect of the invention are described according to appended claims 2 to 13 and in a subsequent section related to the detailed description of several embodiments.

### BRIEF DESCRIPTION OF THE DRAWINGS

The previous and other advantages and features will be more fully understood from the following detailed description of embodiments, with reference to the attached drawings (some of which have already been described in the Prior State of the Art section), which must be considered in an illustrative and non-limiting manner, in which:

FIG. 1 shows current 3GPP IMS architecture.

FIG. 2 shows current GEYSERS advanced PCE, or PCE+, architecture.

FIG. 3 shows the Adaptor Entity as an entity or an interface between the PCRF and PCE+ modules, according to an embodiment of the present invention.

FIG. 4 shows a use case of a fast data migration between datacenters in order to illustrate that the invention enables the support of advanced services in 3GPP networks.

FIG. 5 shows the Adaptor Entity between the PCRF and PCE+ modules and the communication protocol used by these modules to communicate with the Adaptor Entity, according to an embodiment of the present invention.

FIG. 6 shows the workflow between the Adaptor Entity and the PCRF and PCE+ modules in the case of a path computation request/response, according to an embodiment of the present invention.

FIG. 7 shows the workflow between the Adaptor Entity and the PCRF and PCE+ modules in the case of a multi-path computation request/response, according to an embodiment of the present invention.

FIG. 8 shows the workflow between the Adaptor Entity and the PCRF and PCE+ modules in the case of a path computation request/response including a description of the IT end-point, according to an embodiment of the present invention.

FIG. 9 shows the workflow between the Adaptor Entity and the PCRF and PCE+ modules in the case of a path computation request/response when a scheduled path computation is triggered by the PCRF module specifying the time to allocate resources, according to an embodiment of the present invention.

FIG. 10 shows the workflow between the Adaptor Entity and the PCRF and PCE+ modules in the case of a path computation request/response when a scheduled path computation is triggered by the PCRF module and the time to allocate resources is not specified, according to an embodiment of the present invention.

FIG. 11 shows a scheduled path computation triggered by the Adaptor Entity, according to an embodiment of the present invention.

FIG. 12 shows the overall workflow of the architecture integrating 3GPP PCRF and PCE+ by means of the Adaptor Entity.

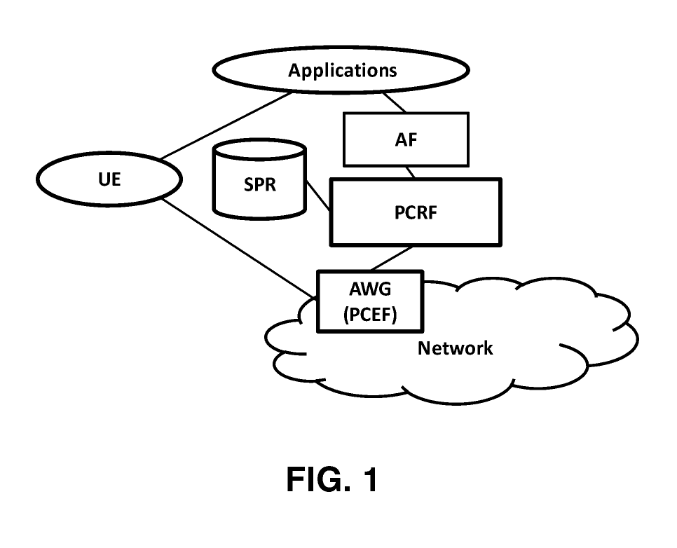

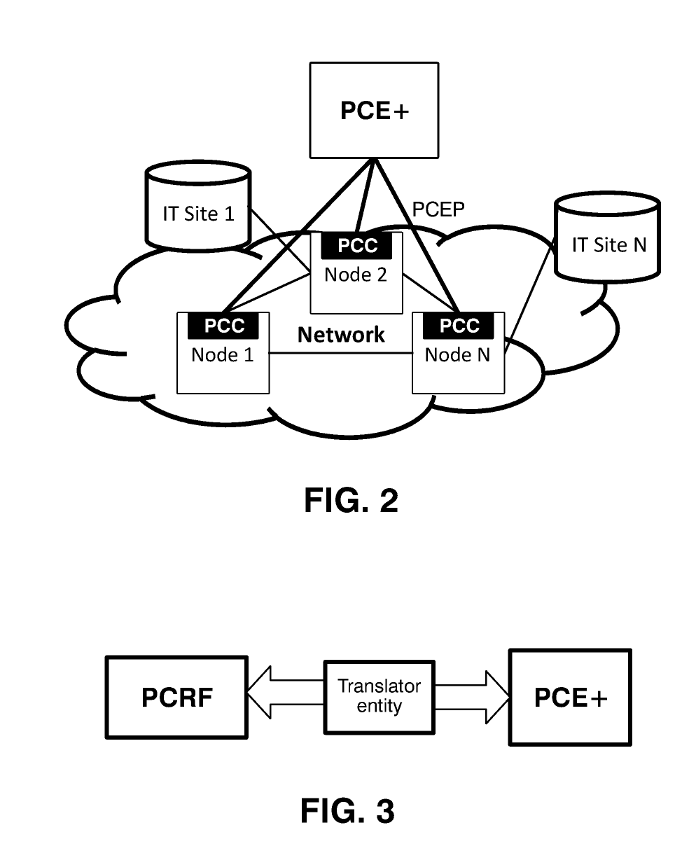

### DETAILED DESCRIPTION OF SEVERAL EMBODIMENTS

The proposed invention describes a new interworking procedure between a 3GPP-PCRF based service layer architecture and an advanced PCE (PCE+). In particular, the proposed invention aims to minimize the required network and IT investments for QoS assurance in convergent networks supporting any kind of service also including IT and scheduled services.

These two technologies i.e. the 3GPP-PCRF and the advanced PCE (PCE+) are two existing elements designed for different environments and currently speak different languages. The communication between them will enable an efficient provisioning of cloud like services (i.e. joint IT and connectivity services) in 3GPP networks. This communication centres the focus of this invention and is based in an Adaptor entity, as shown in FIG. 3, that will be further described.

Indeed, while the PCE+ is capable of delivering scheduled services, the 3GPP-PCRF does not support this functionality. This last reason motivates to define this new entity (capable of managing the scheduling requests) rather than defining a simple inter-protocol interface.

The Adaptor entity can be implemented either as a separated physical element or else as a logical element inside one of the two elements (the PCRF or the PCE+). For sake of a better understanding, in the rest of the document it will be described as a separated element.

Invention's scope is focused on three main requirements for QoS control in converged networks supporting any kind of service also including IT services:

Application awareness: Application-aware networks are able to recognize the traffic from different applications and act accordingly. Application awareness is required in order to guarantee the appropriate QoS for different applications. For example, P2P (best effort), videoconference (real time) and Virtual Machines migration supported over a common infrastructure.

Scalable QoS control mechanisms: The QoS mechanisms (CAC, performance monitoring, QoS differentiated routing, etc.) used in converged networks should be able to manage a huge volume of traffic coming from different users, applications and end-points.

IT information exchange: IT information exchange is needed to enable the support of IT services. IT services comprise the provision of certain amount of storage, CPU or both. Information on the available IT resources must be kept updated consistently.

The proposed invention defines a communication procedure between the 3GPP-PCRF module and the PCE+ in order to provide a 3GPP architecture with the support of seamless (scheduled) joint provisioning of IT and network resources. It aims to minimize total network and IT resources consumption in the provision of complex services with different requirements in terms of storage capacity, CPU, bandwidth and QoS.

Information provided by the PCE+ is used by the PCRF to complete the policies that will be applied to accept new packet flows and allocate the demanded resources.

As the PCRF in a 3GPP architecture utilizes the Diameter language to interoperate within the rest of the elements of the architecture and the PCE+ utilizes the PCEP+ protocol to communicate with the PCCs, a new Adaptor entity needs to be introduced between them to enable the desired interoperation. This entity will also keep consistence of scheduling services, it is needed because the PCRF responds to instantaneous queries while the PCE+ can schedule path reservation.

Three different paradigms are supported by the Adaptor entity for this communication ranging from the common path calculation request to a complex IT+path computation request where the PCE+ is asked to provide IT end-points of certain predefined characteristics as well as an appropriated path to reach it. These service paradigms can be requested normally or in a scheduled fashion.

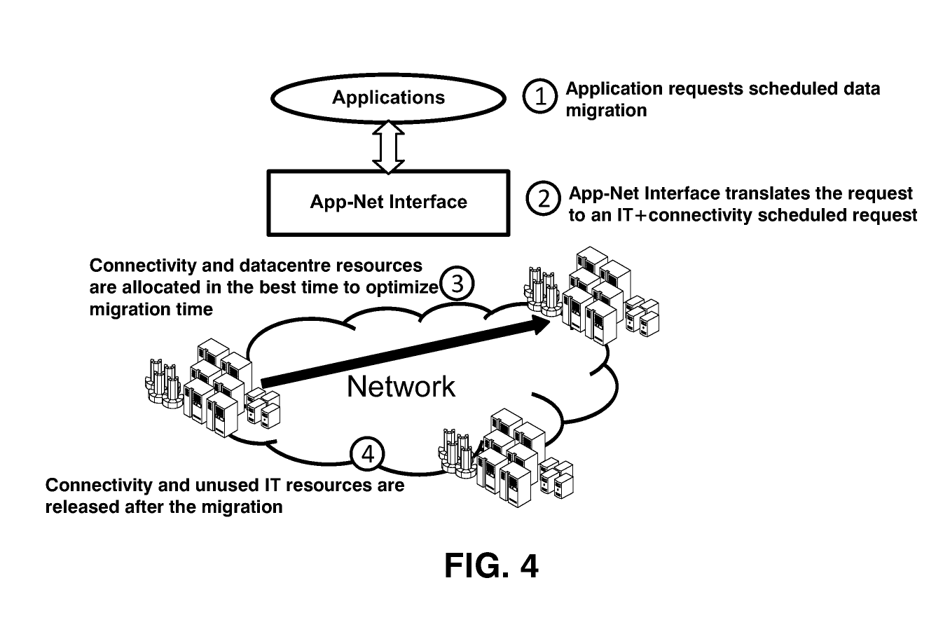

The rational of this invention will enable the support of advanced services in 3GPP networks. FIG. 4 illustrated the applicability of the invention within a use case of scheduled fast data migration between datacenters.

Applications requiring data migrations between datacenters can leverage the capability of the network to decide the best moment to start the migration process.

Simply specifying origin and destine of the migration joint to time and cost constraints the App-Net interface can decide the optimum moment to allocate the required network resources and start the migration process. Indeed, Applications with no geographic constraints, can provide just the origin point and a description of the requirements of the IT destination (amount of storage, number of processors, etc.) and the App-Net interface can seamlessly find an appropriate datacenter where to conduct the migration and effectively process it.

The proposed procedure is explained next:

1.- The service layer (AF) request for a certain amount of resources that can range from only-network resources to interconnected IT resources. In the first case, the objective of the request is the grant of certain QoS for an application data flow entering the network. In the last case, the request will include the description of at least one IT end-point (certain amount of storage, CPU) as well as the grant of certain QoS for the data flow from/towards that end-point. The requests can also schedule the effective resource allocation.

2.- The PCRF evaluates the request and sends a Path Request to the PCE trough the Adaptor entity. This communication centers the focus of the invention and will be further described in the document.

3.- With the information on QoS received from the AF, the Path Response received from the PCE (again through the Adaptor entity) and the subscriber data available from the SPR, the PCRF will derive the rules to forward to the PCEF in order to gate and control each data flow. The PCRF will also forward the request for the provision of the IT resource to the pertinent module—this module is out of scope of the invention and could range from a management system in a Data Center to a hypervisor in a virtualized environment-.

4.- The way data flows are allocated and monitored depends on the underlying network technology and its signaling protocols e.g. packet based MPLS tunnels, GMPLS circuit switched links. This invention doesn't restrict to any specific technology.

Adaptor Entity

To carry out the procedure described before, interaction between the PCRF and the PCE+ needs to be defined to provide integrated view of network and IT resources as well as the management of requests for scheduled resource allocation.

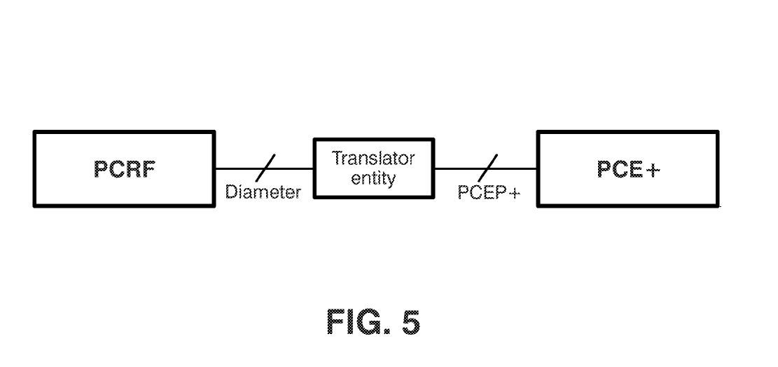

The invention comprises the Adaptor entity, as shown in FIG. 5, between the PCRF and the PCE+. The other elements of this architecture are out of the scope of the invention and could be based on state of the art solutions.

The Adaptor entity allows the PCRF to request paths from the PCE+. The PCE+ has knowledge of the network topology including the IT end-points attached to it. According to it, the Adaptor entity will support the exchange of messages to support:

Path request from the PCRF to the PCE+ and path response from the PCE+ to the PCRF. This is a common path request/response where an optimum path is requested towards a specified destination point in accomplish of certain bandwidth and QoS requirements (delay, jitter, blocking probability, network availability, etc).

Multi-path request from the PCRF to the PCE+ and response from the PCE+ to the PCRF. It is requested a number (specified or not) of paths towards the same destination and the cost associated to each. The PCRF will use this information to choose the optimum path according to its policies.

IT+path request from the PCRF to the PCE+ and response from the PCE+ to the PCRF. It is requested the selection of a number (specified or not) of IT end-points compiling with specified requirements (i.e. amount of storage, number of CPUs) accompanied of a number (specified or not) of paths—and its associated cost—towards each. The PCRF will use this information to choose the optimum set of IT end-points and path according to its policies.

All these three services can be requested scheduled, in which case the time when to execute the allocation can be specified or whether it can be the Adaptor entity the one that computes the optimum time to start the allocation of resources e.g. to maximize network performance, to minimize consumption time, etc.

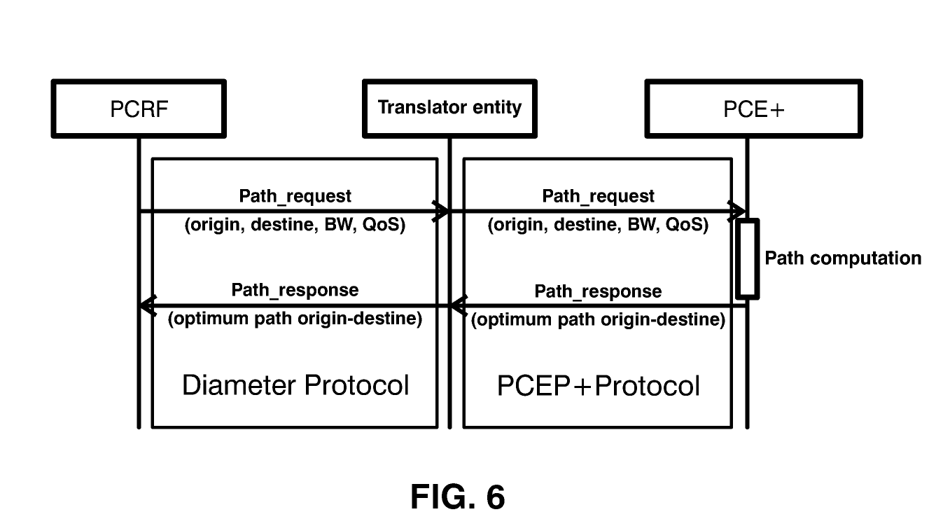

Depending on the request sent to the PCE+, three main workflows can be seen. FIG. 6 showed the common case, where the pair origin-destine is specified and the PCE+ must provide the optimum path between them from an only-network perspective.

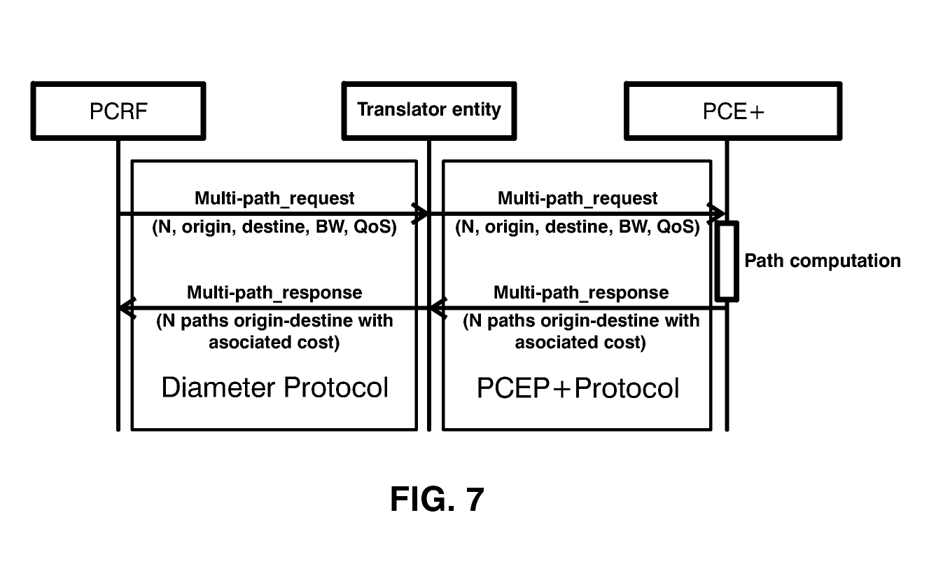

FIG. 7 showed the case of multi-path computation request/response. In this case the process follows the steps below:

1.- The PCRF sends a request for the computation of N (can be omitted) paths between an origin-destination pair specifying bandwidth and QoS requirements.

2.- The Adaptor entity maps the Diameter request to a PCEP+ request message containing the original arguments sent by the PCRF.

3.- The PCE+ computes N (or less if not enough different paths exist) paths between the specified origin-destination pair and associates a network cost for each.

4.- The Adaptor entity maps the PCEP+ response message to a Diameter response confirming the viability of the requested path and containing the arguments computed by the PCE+.

5.- The PCRF chooses the best path according with the last response but in conjunction with subscriber information and operator constraints.

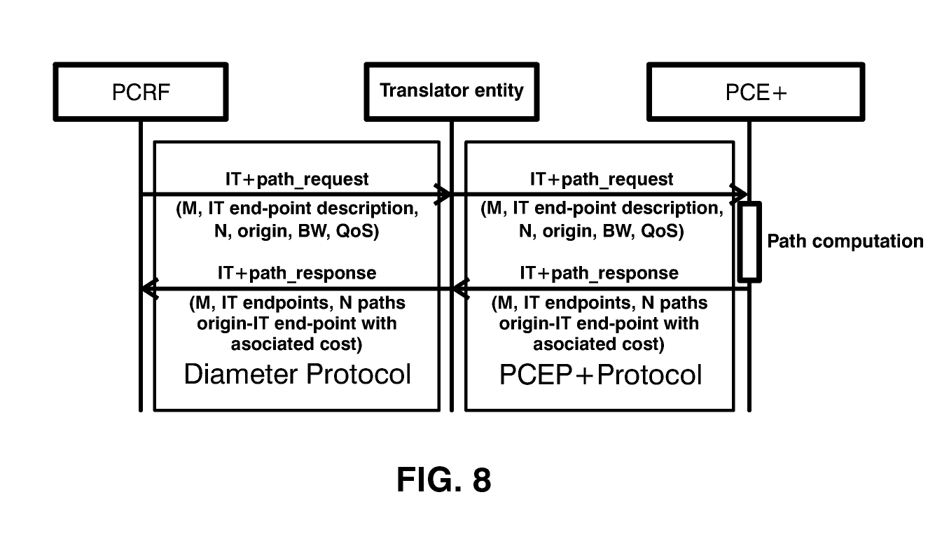

In the case presented in FIG. 8 the PCRF includes in the request a description of the IT end-point (e.g. storage size, CPU mips) and the PCE+ must provide M (or less if there are not enough complying end-points) locations of IT end-points that accomplish the required characteristics. For each IT end-point the PCE+ will provide also N (or less if not enough different paths exist) paths between the origin and the IT end-point location.

The PCRF chooses the optimum combination of IT end-point and path from the N×M possibilities according to the information it has on network cost, subscriber information and operator constraints.

The three previous workflows are slightly modified in case of scheduled resource allocation. Scheduled resource allocation will be triggered in two different situations:

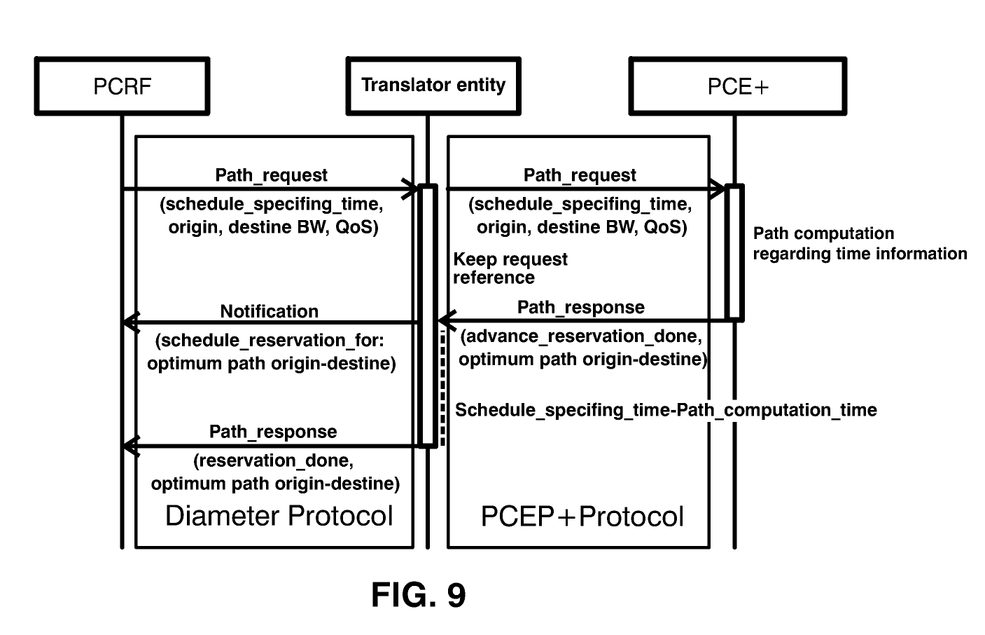

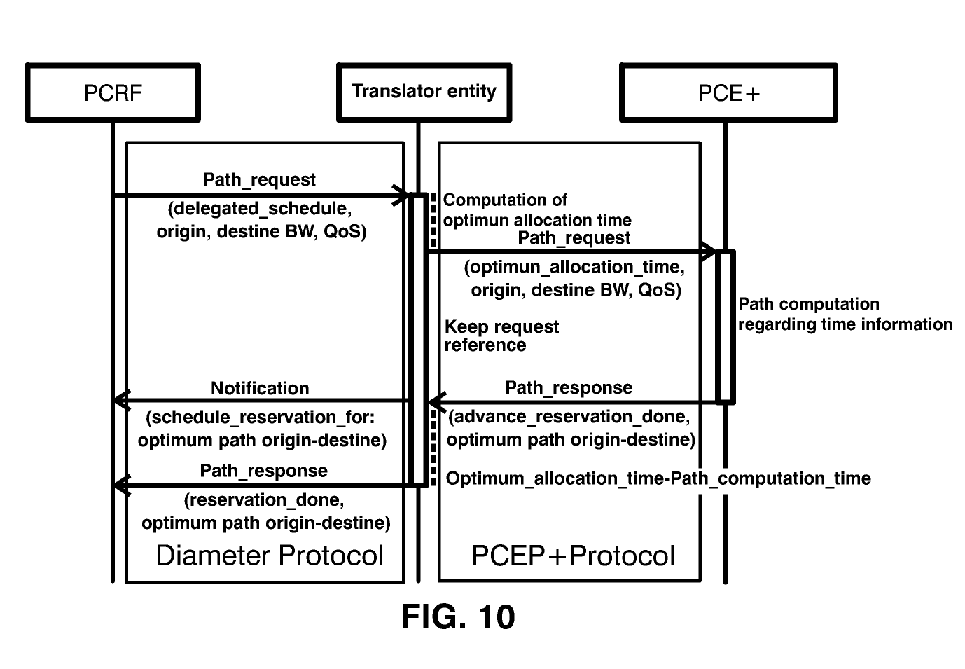

1.- The path request of the PCRF includes a scheduling field whether specifying the time when it want to make effective the allocation of resources, as shown in FIG. 9, or delegating to the Adaptor entity the computation of the best time to initiate the allocation of resources, as shown in FIG. 10. Internal algorithms of the Adaptor entity base the calculation of the optimum time for the allocation of resources in the time information associated to resources usage.

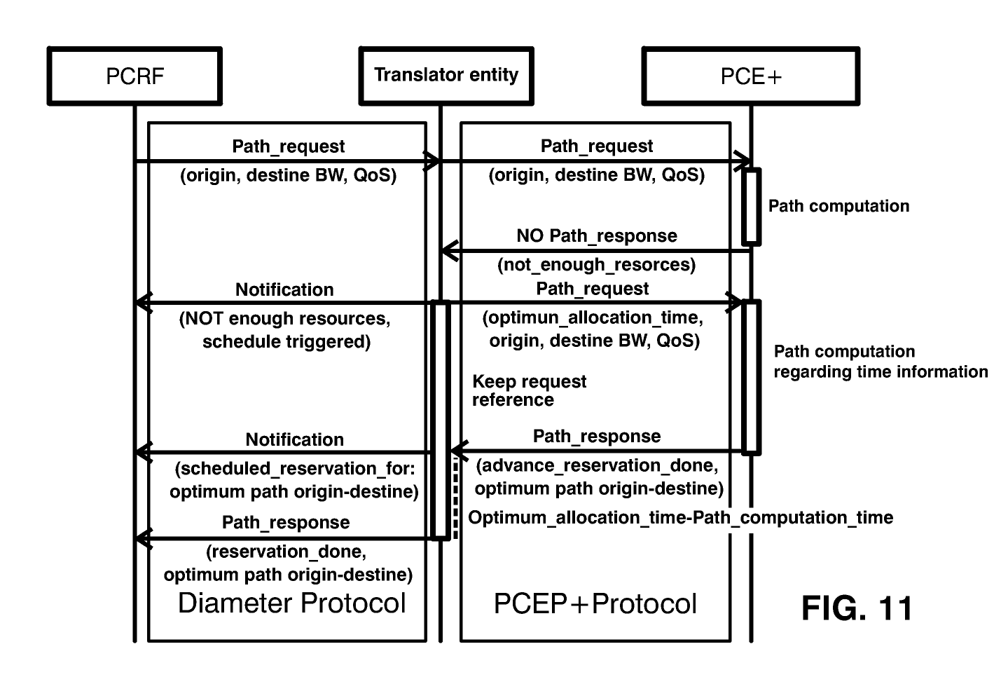

2.- When there are no available resources to satisfy a specific request, the Adaptor entity can be configured to take the initiative and resend the request scheduling the allocation of the needed resources to the time they are released, as shown in FIG. 11.

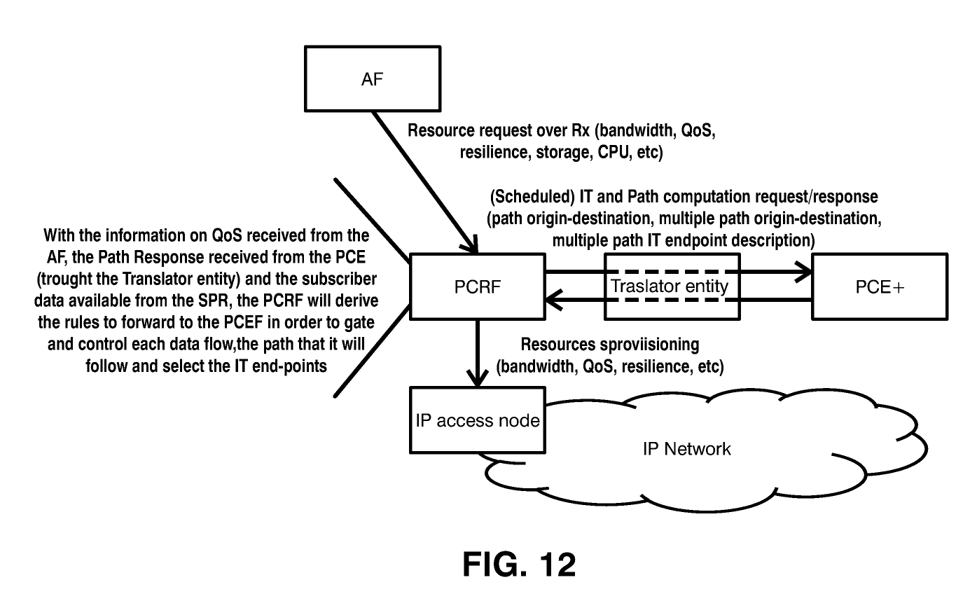

The overall procedure of provisioning resources in the 3GPP IMS architecture integrating the Adaptor entity for the communication with the PCE+ was depicted in FIG. 12.

As mentioned early in the document, the Adaptor entity has the intelligence necessary to compute the optimum allocation time as it keeps track of all the processed requests/responses and the information of duration of each resource reservation. Thanks to this entity, with a single request, applications can totally leverage the network intelligence for the whole reservation process in complex scenarios with high resource usage and even in scenarios with temporary unavailability of resources.

A person skilled in the art could introduce changes and modifications in the embodiments described without departing from the scope of the invention as it is defined in the attached claims.

### Acronyms

3GPP 3rd Generation Partnership Project
AF Application function
AWG Access gateway
BRAS Broadband Remote Access Server
BW Bandwidth
CAC Call admission control
GGSN Gateway GPRS Support Node
DPI Deep packet inspection
IMS IP Multimedia Subsystem
IP Internet Protocol
IT Information Technology
Mips Million instructions per second
P2P Peer to peer
PCC Path Computation Client
PCRF Policy Control and Charging Rules Function
PCE Path Computation Element
PCE+ GEYSERS extended PCE
PCEF Policy and Charging Enforcement Function
PDN Packet data networks
QoS Quality of Service
SPR Subscription Profile Repository
UE User equipment

### References

[1] 3GPP TS 23.203 V9.3.0 (2009-12)

[2] http://tools.ietf.org/html/rfc4655

[3] http://www.geysers.eu/

[4] G. Landi, D. Parniewicz, X. Chen, P. Donadio, Y. Demchenko, J. Jimenez, P. Robinson, P. Drozda, J. Ferrer Riera, E. Escalona, et al.: GEYSERS deliverable D4.1: “NCP+/PCE+ Control Plane Architecture”

[5] McDaid, Cathal, “Overview and Comparison of QoS Control in Next Generation Networks,” palowireless 3G/UMTS Resource Center. http://www.palowireless.com/3g/qos.asp. Accessed Jun. 15, 2010.

1-13. (canceled)

14. A method to minimize network and Information Technology resources consumption in converged networks when provisioning services, said converged networks implementing Policy Control and Charging Rules Function, or PCRF and advanced Path Computation Element, or PCE+ in a 3rd Generation Partnership Project architecture and said converged networks supporting services such as Information Technology, or IT, and scheduled services, comprising performing a communication procedure between a PCRF module and a PCE+ module by means of an adaptor entity in order to provide, by said PCE+ module, information to said PCRF module, said PCRF module using said information to at least allocate network and IT resources demanded when provisioning said services,
wherein, said communication procedure comprises the following steps:
sending, by a service layer of a converged network, a request for resources of a service to said PRCF module;
evaluating, by said PCRF module, said request and sending a Path Request to said PCE+ module via said adaptor entity;
sending, by said PCE+ module, a Path Response to said PCRF module via said adaptor entity;
determining, by said PCRF module, policy rules for said service according to information on Quality of Service received from said service layer, to said Path Response and to subscriber data available form a Subscription Profile Repository; and
forwarding, by said PCRF module, said rules to a Policy and Charging Enforcement Function,
wherein said allocation of network and IT resources is performed in a concrete moment specified in said request sent from said service layer to said PCRF module or in a concrete moment computed by said adaptor entity, and
wherein said adaptor entity is implemented in said PCRF module, in said PCE+ module or in an external module.

15. A method as per claim 14, further comprising using information provided by said PCE+ module to said PCRF module via said adaptor entity to complete policies applied to accept new packet flows when provisioning said services.

16. A method as per claim 14, wherein said resources requested by said service layer are only-network resources or interconnected IT resources and said request schedules resources allocation.

17. A method as per claim 14, comprising:
requesting, by said PCRF module, at least one path towards a specified destination to said PCE+ by means of said Path Request via said adaptor entity in accomplish of certain bandwidth and Quality of Service requirements; and
responding, by said PCE+ module, with said at least one path to said PCRF module by means of said Path Response via said adaptor entity.

18. A method as per claim 14, comprising:
requesting, by said PCRF module, a plurality of paths towards a specified destination and costs associated to said plurality of paths to said PCE+ by means of said Path Request via said adaptor entity;
responding, by said PCE+ module, with said plurality of paths and costs associated to said plurality of paths to said PCRF module by means of said Path Response via said adaptor entity; and
choosing, by said PCRF module, one of said paths of said plurality of paths according to said costs and to policies implemented in said PCRF module.

19. A method as per claim 17, comprising including in said Path Request sent from said PCRF module to said PCE+ module a number of IT endpoints complying with specified requirements and choosing, by said PCRF module, one of said IT endpoints and one path after receiving a Path Response from said PCE+ via said adaptor entity and according to policies implemented in said PCRF module, said Path Response including at least one path and a cost associated to each path to reach each of said IT endpoints.

20. A method as per claim 17, comprising mapping, by said adaptor entity, said Path Request from Diameter protocol to a PCE+ request message containing original arguments sent from said PCRF module and mapping said Path Response from PCE+ protocol to a Diameter response to be sent to said PCRF module.

21. A method as per claim 14, comprising:
sending, by said PCRF module, a Path Request to said PCE+ module, said Path Request including a field indicating the time to make effective said allocation of network and/or IT resources;
receiving, by said Adaptor Entity, said Path Request and forwarding said Path Request to said PCE+ module;
receiving, by said Adaptor Entity, a Path Response from said PCE+ module after path computation in said PCE+ module regarding time information included in said Path Request;
sending, by said Adaptor Entity, a notification to said PCRF module; and
sending, by said Adaptor Entity, said Path Response to said PCRF module at the time to make effective said allocation of network and/or IT resources.

22. A method as per claim 14, comprising:
sending, by said PCRF module, a Path Request to said PCE+ module, said Path Request including a field indicating that the time to make effective said allocation of network and/or IT resources must be calculated;
receiving, by said Adaptor Entity, said Path Request and forwarding said Path Request to said PCE+ module after performing a calculation of said time to make effective said allocation of network and/or IT resources;
receiving, by said Adaptor Entity, a Path Response from said PCE+ module after path computation in said PCE+ module regarding said Path Request and time information calculated by said Adaptor Entity;
sending, by said Adaptor Entity, a notification to said PCRF module; and
sending, by said Adaptor Entity, said Path Response to said PCRF module at the time to make effective said allocation of network and/or IT resources, according to said calculation performed in said Adaptor Entity.

23. A method as per claim 14, comprising:
calculating, by said Adaptor Entity, the time to make effective said allocation of network and/or IT resources when receiving a Path Response from said PCE+ module indicating that there are not available resources to satisfy a specific request, said specific request previously received by said Adaptor Entity in the form of a Path Request and forwarded to said PCE+ module, said Path Request not including any indication of time;
including, by said Adaptor Entity, said calculation of the time to make effective said allocation of network and/or IT resources in said Path Request previously received by said Adaptor Entity;
forwarding, by said Adaptor Entity, said Path Request to said PCE+ entity;
sending, by said Adaptor Entity, a notification to said PCRF module indicating that it has been triggered a scheduled path computation;
receiving, by said Adaptor Entity, a Path Response from said PCE+ module after path computation in said PCE+ module regarding said Path Request and time information calculated by said Adaptor Entity;
sending, by said Adaptor Entity, a notification to said PCRF module; and
sending, by said Adaptor Entity, said Path Response to said PCRF module at the time to make effective said allocation of network and/or IT resources, according to said calculation performed in said Adaptor Entity.
